(19) United States
(12) Patent Application Publication
(10) Pub. No.: US 2026/0070350 A1
(43) Pub. Date: Mar. 12, 2026

(54) CONTROL DEVICE, INKJET RECORDING DEVICE, CONTROL METHOD THEREOF, AND NON-TRANSITORY COMPUTER-READABLE STORAGE MEDIUM

(71) Applicant: CANON KABUSHIKI KAISHA, Tokyo (JP)

(72) Inventors: KOUHEI GOUDA, Kanagawa (JP); TAKUMI KANEKO, Tokyo (JP)

(21) Appl. No.: 19/322,052

(22) Filed: Sep. 8, 2025

(30) Foreign Application Priority Data
Sep. 10, 2024 (JP) 2024-156832

(51) Int. Cl. B41J 11/00; B41J 2/21; B41J 29/393; B41M 3/00; B41M 5/00; B41M 7/00

(52) U.S. Cl. CPC B41J 11/00222; B41J 2/2117; B41J 11/00242; B41J 29/393; B41M 3/008; B41M 5/0047; B41M 7/009

(57) ABSTRACT

A control device controls an inkjet recording device including a recording head discharging ink onto a recording medium that is light transmissive to layer and record an image. The control device comprises a generation unit generating record data for recording an image in which a first, a second, and a third recorded image are layered in this order on one surface of the recording medium, and a drying control unit controlling drying of ink of each layer depending on a recording mode. The drying control unit varies a condition of drying between when the recording mode is a mirror image mode for a case where the first and the third recorded image are mirror images and when the recording mode is a normal mode for a case where the first and the third recorded image are not mirror images.

### BACKGROUND

### Field of the Technology

The present disclosure relates to a control device, an inkjet recording device, a control method thereof, and a non-transitory computer-readable storage medium

### Description of the Related Art

There is a known inkjet recording device (hereinafter, may be referred to as a recording device) that records an image on a recording medium by discharging ink from a recording head onto the recording medium. Such a recording device may layer images on a recording medium that is light transmissive to record an image observable from both sides of the recording medium.

Japanese Patent Laid-Open No. 2014-166762 discloses a method of recording an image using a recording head divided into a first discharge orifice group, a second discharge orifice group, and a third discharge orifice group in a conveyance direction of a recording medium. This method includes a step of forming a first recorded image by discharging a color ink from the first discharge orifice group on a recording medium, a step of forming a second recorded image that shields the first recorded image by discharging a white ink that is a shielding material from the second discharge orifice group, and a step of forming a third recorded image by discharging a color ink from the third discharge orifice group to overlap the color ink on the second recorded image. This enables an observer to observe an image from both sides without transmitting the respective recorded images even when viewed from either the front surface or the back surface of the recording medium.

Here, when an image is layered on the recording medium, if an image of an upper layer is recorded before an image of a lower layer is dried, the ink of the upper layer is immersed in the image of the lower layer, and the quality of the image is deteriorated. Therefore, it has been necessary to record the image of the upper layer after drying the image of the lower layer.

However, when images are layered and recorded, there is a problem that the images cannot be appropriately dried if dried under the same conditions regardless of the layered image.

### SUMMARY

Therefore, the present disclosure provides a technique that can appropriately dry images when the images are layered and recorded.

The present disclosure in its first aspect provides a control device that controls an inkjet recording device including a recording head that discharges ink onto a recording medium that is light transmissive to layer and record an image, the control device comprising: a generation unit that generates record data for recording an image in which at least a first recorded image, a second recorded image, and a third recorded image are layered in this order on one surface of the recording medium; and a drying control unit that controls drying of ink of each layer depending on a recording mode, which is a mode for recording an image, wherein the drying control unit varies a condition of drying between when the recording mode is a mirror image mode for a case where the first recorded image and the third recorded image are mirror images and when the recording mode is a normal mode for a case where the first recorded image and the third recorded image are not mirror images.

The present disclosure in its second aspect provides a control method that controls an inkjet recording device including a recording head that discharges ink onto a recording medium that is light transmissive to layer and record an image, the method comprising: generating record data for recording an image in which at least a first recorded image, a second recorded image, and a third recorded image are layered in this order on one surface of the recording medium; and controlling drying of ink of each layer depending on a recording mode, which is a mode for recording an image, wherein in the controlling of drying, a condition of drying is varied between when the recording mode is a mirror image mode for a case where the first recorded image and the third recorded image are mirror images and when the recording mode is a normal mode for a case where the first recorded image and the third recorded image are not mirror images.

The present disclosure in its third aspect provides a non-transitory computer-readable storage medium storing a computer program for causing, when loaded and executed by a computer that controls an inkjet recording device t including a recording head that discharges ink onto a recording medium that is light transmissive to layer and record an image, the computer to: generate record data for recording an image in which at least a first recorded image, a second recorded image, and a third recorded image are layered in this order on one surface of the recording medium; and control drying of ink of each layer depending on a recording mode, which is a mode for recording an image, wherein in the controlling of drying, a condition of drying is varied between when the recording mode is a mirror image mode for a case where the first recorded image and the third recorded image are mirror images and when the recording mode is a normal mode for a case where the first recorded image and the third recorded image are not mirror images.

Features of the present disclosure will become apparent from the following description of embodiments with reference to the attached drawings. The following description of embodiments is described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a view describing immersion of ink in a layered image.

FIG. 2 is a perspective view of an appearance of an inkjet recording device according to an embodiment.

FIG. 3 is a side view illustrating an internal configuration of the recording device.

FIG. 4 is a plan view of a recording head according to the embodiment.

FIG. 5 is a block diagram illustrating a control system of the inkjet recording device according to the embodiment.

FIG. 6 is a view showing a flowchart of record data generation processing of the embodiment.

FIG. 7A is a view describing a recording process in a white layer mode by multipass layered image recording.

FIG. 7B is a view describing the recording process in the white layer mode by multipass layered image recording.

FIG. 7C is a view describing the recording process in the white layer mode by multipass layered image recording.

FIG. 7D is a view describing the recording process in the white layer mode by multipass layered image recording.

FIG. 7E is a view describing the recording process in the white layer mode by multipass layered image recording.

FIG. 7F is a view describing the recording process in the white layer mode by multipass layered image recording.

FIG. 8 is a view for describing a mask pattern.

FIG. 9A is a view describing recording of a color ink in the first four passes.

FIG. 9B is a view describing recording of a white ink in the middle four passes.

FIG. 9C is a view describing recording of a color ink in the last four passes.

FIG. 9D is a view illustrating recording of a color RCT in the first four passes.

FIG. 9E is a view describing recording of a WRCT in the middle four passes.

FIG. 9F is a view describing recording of the color RCT in the last four passes.

FIG. 10 is a view showing a flowchart of recording mode setting processing according to the embodiment.

FIG. 11 is a view of a mode setting screen on which the user selects a recording mode.

FIG. 12 is a view describing an influence of immersion when the first recorded image and the third recorded image are non-mirror images.

FIG. 13 is a view describing an influence of immersion when the first recorded image and the third recorded image are mirror images.

FIG. 14 is an exploded perspective view illustrating an example of an evaluation image for evaluation in the embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### Recording Device Configuration

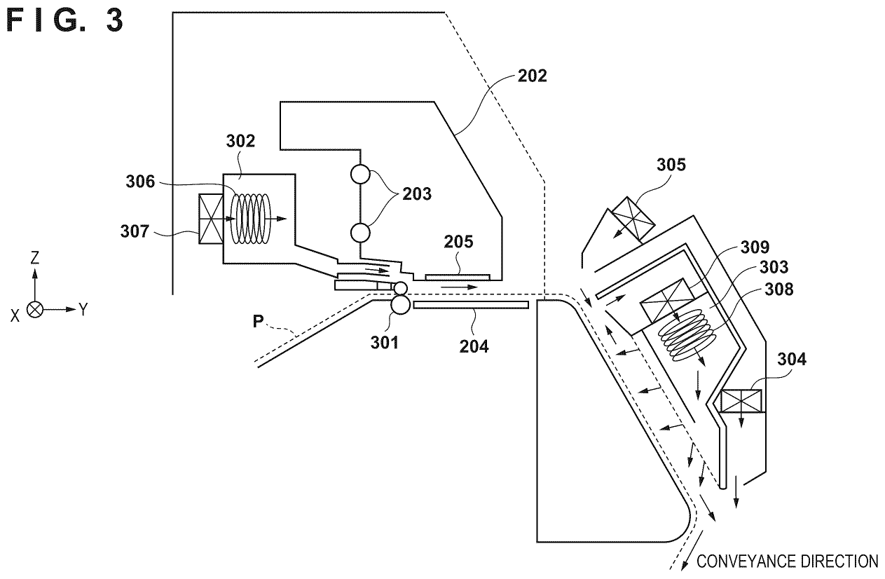

FIG. 2 is a perspective view of an appearance of an inkjet recording device (hereinafter, also referred to as a recording device) according to the present embodiment. FIG. 3 is a side view illustrating an internal configuration of the recording device. The inkjet recording device of the present embodiment is what is called a serial scanning recording device. The inkjet recording device records an image by scanning the recording head in a scanning direction that is a direction (here, vertical direction) intersecting a Y direction (conveyance direction) in which a recording medium P is conveyed. Note that the scanning direction may be referred to as a main scanning direction. For example, the inkjet recording device of the present embodiment records an image on a recording medium that is light transmissive. More specifically, the inkjet recording device records, on one surface of the recording medium, an image layered in the order of at least the first recorded image, the second recorded image, and the third recorded image. Note that the first recorded image and the third recorded image are images recorded with a color ink described later. The second recorded image is an image recorded with a white ink or the like, and functions as a shielding layer that suppresses transmission of the first recorded image and the third recorded image.

Outlines of the configuration of the inkjet recording device and the operation during image recording will be described with reference to FIGS. 2 and 3. During image recording, the recording medium P held by a spool 201 is conveyed in the Y direction by the spool 201 of a conveyance unit 301 driven by an LF motor 511 described later, via a gear. A carriage unit 202 scans on the recording medium P along a guide shaft 203 extending in an X direction by a CR motor 512 described later from a predetermined conveyance position. Specifically, the carriage unit 202 reciprocally scans (reciprocally moves) between a forward path in the +X direction and a backward path in the −X direction. In synchronization with timing based on a position signal obtained by an encoder 206 in the X direction, a recording head 205 attached to the carriage unit 202 being scanned discharges ink from a discharge orifice to record an image on the recording medium P.

Similarly to the recording head 205, the recording device processes a detection signal corresponding to the position of the carriage unit 202 in synchronization with the timing based on the position signal obtained by the encoder 206 in the process of reciprocally scanning of the carriage unit 202. Note that in the present embodiment, a carriage belt is used to transmit the driving force from the CR motor 512 to the carriage unit 202. The method of driving the carriage unit 202 may be a method including, in place of the carriage belt, a lead screw rotationally driven by the CR motor 512, for example, and extending in the X direction, and an engagement portion provided at the carriage unit 202 and engaging with a groove of the lead screw. The method of driving the carriage unit 202 may be another driving system.

The recording medium P is conveyed while being nipped between a paper feed roller and a pinch roller of the conveyance unit 301, and is guided to a recording position on a platen 204 (scan area of the recording head 205). In a normal pause state, a face surface of the recording head 205 is capped. Therefore, the cap is opened prior to recording, and the recording head 205 and the carriage unit 202 are brought into a scannable state. Thereafter, when data for one scan is accumulated in a buffer, the recording device discharges ink from the recording head 205 while causing the carriage unit 202 to scan by the CR motor 512 to record an image on the recording medium P.

The conveyance unit 301 includes the paper feed roller and the pinch roller, and conveys the recording medium P while nipping it. The recording medium P is conveyed while being held by the spool 201, and the recording head 205 discharges ink to record an image on the recording medium P. The recording medium P is wound by the spool 201 for winding and serves as a roll-shaped winding medium. The recording head 205 discharges ink onto the recording medium P while being scanned in the X direction by the carriage unit 202. At this time, the conveyance unit 301 intermittently conveys the recording medium P in the +Y direction, whereby an image is formed in a plane of the recording medium P. The platen 204 opposes the scan area of the recording head 205 and the carriage unit 202, and sucks the back surface of the recording medium P in order to prevent floating of the recording medium P.

Next, a configuration for drying and fixing ink will be described.

A platen air blow unit 302 blows air heated by a heater 306 to the surface of the recording medium P on the platen 204 by blowing the air with a fan 307. By this, the platen air blow unit 302 promotes evaporation of moisture contained in the ink discharged on the front surface of the recording medium P on the platen 204, and promotes fixing of the ink. The platen air blow unit 302 is an example of a drying unit.

A fixing unit 303 dries and fixes the ink applied to the recording medium P. The fixing unit 303 has a hollow substantially box shape. The bottom surface of the fixing unit 303 opposes the conveyance surface of the recording medium P. The fixing unit 303 blows hot air heated by a heater 308 from the bottom surface toward the recording medium P by blowing the hot air by a fan 309. By this, the fixing unit 303 raises the temperature of the ink and the recording medium P to evaporate water and a solvent contained in the ink and form an emulsion into a film.

A downflow unit 304 blows, in a floor direction, hot air exhausted from the fixing unit 303. An air curtain unit 305 is provided between the platen 204 and the fixing unit 303. The air curtain unit 305 prevents ink mist flowing by the platen air blow unit 302 from entering inside the fixing unit 303.

### Head Configuration

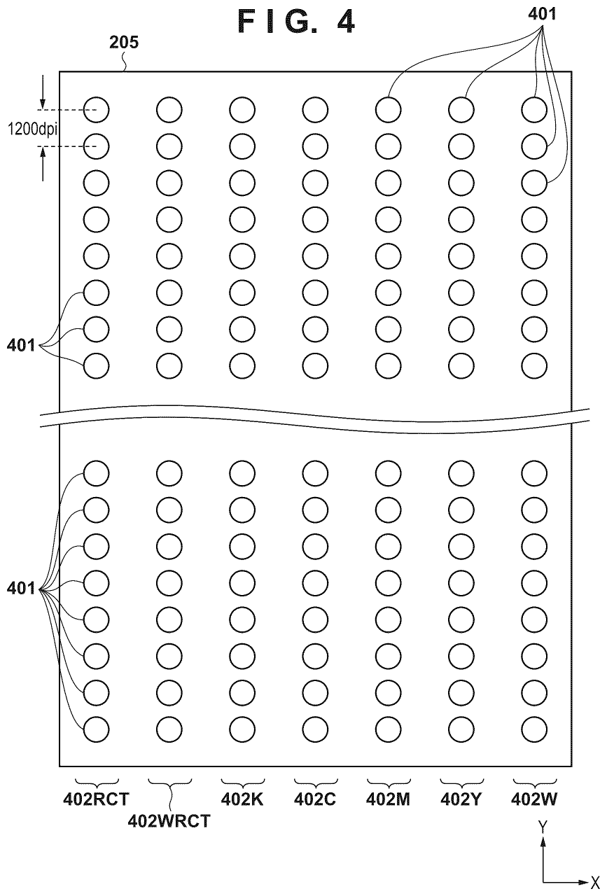

FIG. 4 is a plan view of the recording head 205 according to the present embodiment. The recording head 205 includes a discharge orifice array 402K that discharges a black ink (K), a discharge orifice array 402C that discharges a cyan ink (C), a discharge orifice array 402M that discharges a magenta ink (M), and a discharge orifice array 402Y that discharges a yellow ink (Y) as inks containing color materials. The black ink (K), the cyan ink (C), the magenta ink (M), and the yellow ink (Y) contain respective color materials, and therefore, these inks are also referred to as color inks for the sake of simplicity in the following description.

The recording device of the present embodiment forms, between the first recorded image and the third recorded image, a second recorded image, which is a shielding layer for shielding the first recorded image, which is a color image of the first layer, and the third recorded image, which is a color image of the third layer, on the recording medium P. The shielding layer is formed of a white ink containing a white pigment. The white ink is used as specific color ink having a specific color. The recording head 205 includes a discharge orifice array 402W that discharges the white ink (W).

The recording head 205 includes a discharge orifice array 402RCT that discharges a reaction liquid ink (also called RCT, RCT ink, or color RCT ink) not containing a color material. This reaction liquid ink does not contain a color material, but contains a reactant agent that reacts with a color material contained in the color ink and a water-soluble resin emulsion. Therefore, the reaction liquid ink comes into contact with and reacts with the color ink on the recording medium P, thereby aggregating the color ink to reduce spreading. The recording head 205 includes the discharge orifice array 402RCT that discharges the reaction liquid ink.

The recording device of the present embodiment separately prepares a white reaction liquid ink (also called WRCT or WRCT ink) dedicated to the white ink, separately from the reaction liquid ink for the color ink, and includes a discharge orifice array 402WRCT for discharging the WRCT ink. The WRCT ink is a reaction liquid used for the white ink. The WRCT ink is used to appropriately aggregate the white ink containing a large amount of color material on the recording medium P to form a layered image with the color ink. The recording head 205 includes the discharge orifice array 402WRCT that discharges the WRCT ink.

Note that the recording device of the present embodiment includes four types of color inks (K, C, M, and Y) as color inks, but the color inks are not limited to them. For example, the color inks may include a light cyan ink (Lc) and a light magenta ink (Lm) as light inks. The color inks may include a gray ink (GY) as a light ink, and may include any of a green ink (G), an orange ink (OR), a red ink (R), and a blue ink (B), which are spot inks.

In the recording head 205, the discharge orifice arrays 402RCT, 402WRCT, 402K, 402C, 402M, 402Y, and 402W are arranged in this order from the left side to the right side in the X direction.

In the discharge orifice arrays 402RCT, 402WRCT, 402K, 402C, 402M, 402Y, and 402W, 1280 discharge orifices 401 for discharging respective inks are formed. The 1280 discharge orifices 401 are arrayed in the Y direction (conveyance direction) at a density of 1200 dpi. Note that the amount of ink discharged from one discharge orifice 401 at a time is, for example, about 6 pl.

Each of the discharge orifice arrays 402RCT, 402WRCT, 402K, 402C, 402M, 402Y, and 402W is connected to an ink tank (not illustrated) that stores a corresponding ink. By this, the ink is supplied to each of the discharge orifice arrays of the recording head 205. The recording head 205 and the ink tank may be integrally formed, or may be separable from each other.

The recording head 205 includes an energy generation element (hereinafter, also called a recording element) that generates discharge energy for discharging the ink from the discharge orifice. In the present embodiment, an electrothermal converter that locally heats ink to cause film boiling and discharges the ink by the pressure thereof is used as an energy generation element. However, the energy generation element is not limited to the electrothermal converter, and may be a piezoelectric element.

### Material Overview

Details of each ink constituting an ink set used in the present embodiment will be described. Hereinafter, “part” and “%” are based on mass unless otherwise specified.

### 1. Ink Composition

Hereinafter, the composition of each ink will be described in detail. The color inks (K, C, M, and Y inks) used in the present embodiment contain color materials pigment other than white. As the color material, black-based, cyan-based, magenta-based, and yellow-based color material pigments are used. As described later, these color material pigments are produced as a dispersed material aqueous solution in an aqueous solution, and then blended with other predetermined material components to be adjusted as an ink.

The white (W) ink of the present embodiment contains a white color material as a color material. Titanium oxide particles may be used as the white color material of the white ink. Titanium oxide has a rutile type, an anatase type, and a brookite type in terms of its crystal structure. The titanium oxide may be, for example, a rutile type having low photocatalytic activity. Examples of a method of producing titanium oxide include a sulfuric acid method and a chlorine method. The content (mass %) of titanium oxide particles in ink may be 5 mass % or more and 20 mass % or less based on the total mass of the ink from the viewpoint of ink stability.

The zeta potential of the titanium oxide particles in pure water may be 0 mV or more. The zeta potential is an index indicating the charge state of the surface of the titanium oxide particles. The zeta potential is measured by electrophoretic light scattering. When the positive charge amount is larger than the negative charge amount on the surface of the titanium oxide particles, they are easily adsorbed to the resin having an anionic group, and therefore the dispersion stability of titanium oxide is improved. For example, the zeta potential may be 40 mV or less. By this, the anionic group of the resin is excessively consumed, and shortage of charge repulsion between the titanium oxide particles can be suppressed.

As the white color material of the white ink, it is also possible to use resin particles having a hollow structure in combination with titanium oxide particles. Examples of the resin particles having a hollow structure include resin particles containing units derived from styrene and acrylic such as MH5055 (manufactured by Zeon Corporation) and ROPAQUE OP-62, OP-84J, OP-91, HP-1055, HP-91, and ULTRA (manufactured by Rohm and Haas); and resin particles containing units derived from crosslinked styrene and acrylic such as SX-863(A), 864(B), 866(A), 866(B), and 868 (manufactured by JSR Corporation), and ROPAQUE ULTRA E and ULTRA DUAL (manufactured by Rohm and Haas).

Note that the white ink contains the above-described white color material as a main component, but may contain other color materials within a range to an extent that does not impair whiteness in order to adjust a slight white color tint visually recognized by reflected light or the like.

The color inks (K, C, M, and Y), the reaction liquid inks (RCT and WRCT), and the white ink (W) used in the present embodiment all contain a water-soluble organic solvent. The boiling point of the water-soluble organic solvent may be 150° C. or higher and 300° C. or lower. This can improve the wettability and moisture retention of the face surface of the recording head 205. The water-soluble organic solvent may be a ketone-based compound such as acetone or cyclohexanone, an ethylene glycol derivative such as tetraethylene glycol dimethyl ether, a heterocyclic compound having a lactam structure represented by N-methyl-pyrrolidone or 2-pyrrolidone, or the like. This can improve the function of a film formation aid for the resin particles and the swelling solubility to the recording medium P on which a resin layer is formed. The content of the water-soluble organic solvent may be 3 wt % or more and 30 wt % or less from the viewpoint of discharge performance. This can improve the discharge performance.

The water-soluble organic solvent may be, for example, alkyl alcohols having a carbon number 1 to 4 such as methyl alcohol, ethyl alcohol, n-propyl alcohol, isopropyl alcohol, n-butyl alcohol, sec-butyl alcohol, or tert-butyl alcohol. The water-soluble organic solvent may be, for example, amides such as dimethylformamide or dimethylacetamide. The water-soluble organic solvent may be, for example, a ketone or ketoalcohols such as acetone or diacetone alcohol. The water-soluble organic solvent may be, for example, ethers such as tetrahydrofuran or dioxane. The water-soluble organic solvent may be, for example, polyalkylene glycols such as polyethylene glycol or polypropylene glycol. The water-soluble organic solvent may be, for example, alkylene glycols in which an alkylene group contains 2 to 6 carbon atoms, such as ethylene glycol, propylene glycol, butylene glycol, triethylene glycol, 1,2,6-hexanetriol, thiodiglycol, hexylene glycol, and diethylene glycol. The water-soluble organic solvent may be, for example, a lower alkyl ether acetate such as polyethylene glycol monomethyl ether acetate. The water-soluble organic solvent may be, for example, glycerin. The water-soluble organic solvent may be, for example, lower alkyl ethers of a polyhydric alcohol such as ethylene glycol monomethyl (or ethyl) ether, diethylene glycol methyl (or ethyl) ether, and triethylene glycol monomethyl (or ethyl) ether. The water-soluble organic solvent may be, for example, a polyhydric alcohol such as trimethylolpropane or trimethylolethane. The water-soluble organic solvent may be, for example, N-methyl-2 pyrrolidone, 2-pyrrolidone, or 1,3-dimethyl-2-imidazolidinone. The above-described water-soluble organic solvent may be used alone or as a mixture.

As the water contained in the ink, deionized water may be used. Note that the content of the water-soluble organic solvent in the reaction liquids (RCT and WRCT) is not particularly limited. In addition to the above-described components, an antifoaming agent, a preservative, an anti-mold agent, and the like may be added to the color inks (K, C, M, and Y) and the white ink (W) in order to have desired physical properties as necessary.

The color inks (K, C, M, and Y), the reaction liquids (RCT and WRCT), and the white ink (W) used in the present embodiment all contain a surfactant. The surfactant improves the wettability and spreadability of the ink with respect to the recording medium. The larger the added amount of the surfactant is, the stronger the property of reducing the surface tension of the ink, and the wettability and spreadability of the ink with respect to the recording medium are improved. In the present embodiment, a small amount of acetylene glycol EO adduct or the like was added as a surfactant to the ink, and the static surface tension of each ink was adjusted to be 30 dyn/cm or less, and the difference in static surface tension between the color inks was adjusted to be 2 dyn/cm or less. More specifically, the static surface tension of each color ink was adjusted to be about 22 to 24 dyn/cm. The static surface tension of the ink was measured using a fully automatic surface tensiometer CBVP-Z (manufactured by Kyowa Interface Science Co., Ltd.). The measurement instrument is not limited to the above-described device as long as it can measure the static surface tension of the ink.

The pH of each color ink of the present embodiment is stable on the alkali side, and the value thereof is 8.5 to 9.5. The pH of each color ink may be 7.0 or more and 10.0 or less. This prevents elution and deterioration of members in contact with each color ink in the recording device and the recording head 205, reduction in solubility of the dispersion resin in the color inks, and the like. The pH of the ink was measured using pH METER model F-52 manufactured by HORIBA, Ltd. Note that the measurement instrument is not limited to those exemplified above as long as it can measure the pH of the ink.

### 2. Water-Soluble Resin Emulsion

The color inks (K, C, M, and Y) and the white ink (W) used in the present embodiment contain a water-soluble resin emulsion. In the present embodiment, the “water-soluble resin emulsion” means polymer fine particles present in a state of being dispersed in water. Specifically, the water-soluble resin emulsion may be acrylic resin fine particles synthesized by emulsion polymerization of monomers such as (meth)acrylic acid alkyl ester and (meth)acrylic acid alkyl amide, styrene-acrylic resin fine particles synthesized by emulsion polymerization of styrene monomers such as (meth)acrylic acid alkyl ester and (meth)acrylic acid alkyl amide, polyethylene resin fine particles, polypropylene resin fine particles, polyurethane resin fine particles, styrene-butadiene resin fine particles, and the like. The water-soluble resin emulsion may be resin fine particles obtained by emulsion polymerization of any of core-shell type resin fine particles having different polymer compositions in a core portion and a shell portion constituting resin fine particles, acrylic fine particles synthesized in advance for controlling the particle diameter, and the like as seed particles in the periphery thereof. Furthermore, the water-soluble resin emulsion may be hybrid type resin fine particles in which different resin fine particles such as acrylic resin fine particles and urethane resin fine particles are chemically bonded.

### 3. Slip Agent

The color ink and the white ink used in the present embodiment contain a slip agent. In the present embodiment, the “slip agent” means wax particles or silicone oil. Specifically, the wax particles may be synthetic wax particles such as Fischer-Tropsch wax (EMUSTAR-6315) manufactured by Nippon Seiro Co., Ltd., and polyolefin wax (HITEC E-9500) manufactured by Toho Chemical Industry Co., Ltd. The wax particles may be natural wax particles such as carnauba wax (Celosol 524) manufactured by Chukyo Yushi Co., Ltd., paraffin wax (AQUACER497) manufactured by BYK Japan KK, and the like. The slip agent may be silicone oil, and examples thereof include polyether-modified silicone (BYK333) manufactured by BYK Japan KK.

### 4. Reactant Agent

The recording device of the present embodiment may adopt as necessary a system for recording using a reaction liquid ink for insolubilizing a part or all of the solid components of the color inks (K, C, M, and Y) and the white ink (W). This enables the recording device of the present embodiment to solve image problems such as bleeding and beading.

The reactant agent contained in the reaction liquid ink may be, for example, a polyvalent metal ion (e.g., magnesium sulfate, magnesium nitrate, magnesium chloride, emulsified calcium, aluminum sulfate, iron chloride, and the like). This can insolubilize the dissolved dye and the dispersed pigment and resin. One type of aggregation action using such a cation may be a system using a cationic polymer aggregating agent having a low molecular weight. This can realize charge neutralization of the water-soluble resin emulsion and insolubilization of the anionic soluble substance.

Other reaction systems include an insolubilization system using a reaction liquid ink using a difference in pH. As described above, the color inks used in the inkjet recording device in general are mostly stable on the alkali side due to the properties of the color material and the like. Specifically, the pH of the color ink is generally 7.0 or more and 10.0 or less, and is mainly around 8.5 to 9.5 from an industrial point of view and in consideration of an influence of an external environment and the like. In order to aggregate and solidify the color ink of such a system, a stable state can be broken by mixing an acidic solution and changing the pH of the color ink, and the dispersed components can be aggregated. For the purpose of such an action, an acidic solution can also be used as the reaction liquid ink.

### 5. Recording Medium

The recording medium P in the present embodiment is not limited to paper or the like generally used in an inkjet recording device, and includes those that can receive ink, such as cloth, a plastic film, a metal plate, glass, ceramics, resin, wood, and leather. In particular, a “non-permeable recording medium” refers to a recording medium having no ink permeability of aqueous ink. A “low-permeable recording medium” means a recording medium having ink permeability of the aqueous ink that is lower than that of generally used paper or the like. The non-permeable recording medium may be, for example, one not produced as a recording medium for aqueous inkjet ink, such as glass, plastic, film, or Yupo. The non-permeable recording medium may be one having not been subjected to surface treatment for inkjet recording (one on which an ink absorption layer is not formed), such as a plastic film and a base material such as paper or the like coated with plastic. The plastic may be, for example, polyvinyl chloride, polyethylene terephthalate, polycarbonate, polystyrene, polyurethane, polyethylene, polypropylene, or the like. The low-permeable recording medium may be, for example, a recording medium such as recording paper used for offset recording or the like such as art paper or coated paper.

### Control System of Recording Device

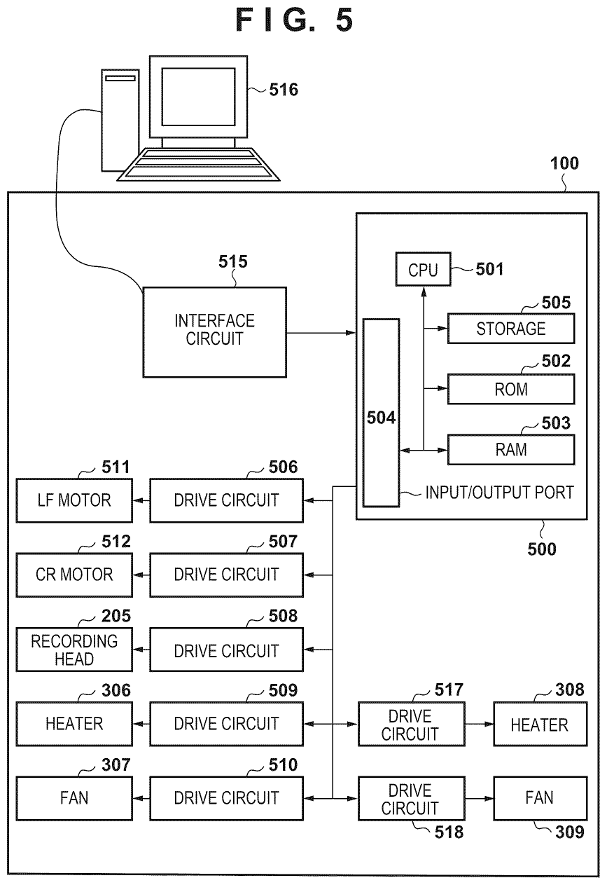

FIG. 5 is a block diagram illustrating a control system of an inkjet recording device 100 according to an embodiment. The control system of the inkjet recording device 100 will be described with reference to FIG. 5. The inkjet recording device 100 of the present embodiment includes a main control unit 500, the LF motor 511, the CR motor 512, a drive circuit 506, a drive circuit 507, a drive circuit 508, a drive circuit 509, a drive circuit 510, a drive circuit 517, a drive circuit 518, the recording head 205, the heater 306, the fan 307, the heater 308, the fan 309, and an interface circuit 515.

The main control unit 500 may be a computer. The main control unit 500 includes a CPU 501, a ROM 502, a RAM 503, an input/output port 504, and a storage 505.

The CPU 501 is an abbreviation for central processing unit, and is an arithmetic processing device. The CPU 501 controls the entire recording device. The CPU 501 executes, for example, processing operations such as calculation, selection, determination, and control, and recording operations. The main control unit 500 may include other processors such as a micro processing unit (MPU), a graphics processing unit (GPU), a neural processing unit (NPU), and a quantum processing unit (QPU) in place of the CPU 501 or in addition to the CPU 501. Some or all of the functions of the main control unit 500 are realized by one or a plurality of processors including the CPU 501 reading a program stored in the storage 505, developing the program in the RAM 503, and executing the program. Some or all of the functions of the main control unit 500 may be realized by one or a plurality of circuits such as an application specific integrated circuit (ASIC) and a programmable logic device (PLD) including a field programmable gate array (FPGA).

The CPU 501 generates record data for recorded images layered in the order of the first recorded image, the second recorded image, and the third recorded image on one surface of the recording medium. The CPU 501 controls drying of the ink of each layer depending on the recording mode, which is a mode for recording an image. For example, the CPU 501 controls drying based on drying time, the temperature and the airflow speed of air blowing for drying, and the like. The CPU 501 is an example of a generation unit and a drying control unit.

The ROM 502 is an abbreviation for read only memory, and is a nonvolatile storage device. The ROM 502 stores a control program and the like to be executed by the CPU 501.

The RAM 503 is an abbreviation for random access memory, and is a memory that can read and write data at high speed. The RAM 503 is used as a buffer or the like for record data. The RAM 503 functions as a work area when the CPU 501 executes a program.

The storage 505 may be a nonvolatile, large-capacity storage device such as a hard disk drive (HDD) and a solid state drive (SSD). The storage 505 stores, for example, a computer program to be executed by the CPU 501, data such as a mask pattern necessary for execution of the program, and data such as image data that is a processing target of the program.

The input/output port 504 is a port for inputting/outputting data to/from another device. The input/output port 504 is connected to the drive circuits 506, 507, 508, 509, 510, 517, and 518 for driving the LF motor 511 also called a conveyance motor, the CR motor 512 also called a carriage motor, the recording head 205, the heater 306, the fan 307, the heater 308, the fan 309, an actuator, and the like.

The interface circuit 515 is an interface for transmitting/receiving data to/from an external device. The interface circuit 515 connects, for example, the main control unit 500 and a PC 516, which is a host computer, so as to be able to transmit and receive data. PC is an abbreviation for personal computer. The interface circuit 515 receives, for example, selection of a recording mode described later from the PC 516 and passes the selection to the main control unit 500.

### Data Processing Process

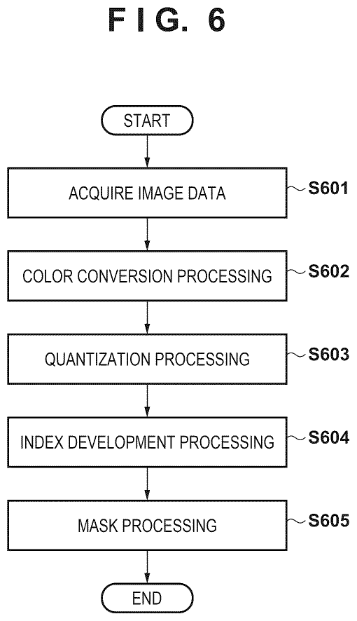

FIG. 6 is a view showing a flowchart of record data generation processing of the embodiment. Record data generation processing to be executed by the CPU 501 according to a computer program will be described with reference to FIG. 6. The CPU 501 reads a computer program for record data generation processing stored in the storage 505 and develops the computer program in the RAM 503, thereby executing the record data generation processing.

In step S601, the CPU 501 acquires image data input from the PC 516, which is a host computer. The image data may be luminance data. The image data is data in which the luminance value of each color of red (R), green (G), and blue (B) is indicated by 256 values from 0 to 255 of 8 bits.

Next, in step S602, the CPU 501 executes color conversion processing of converting RGB data of the image data into CMYK data corresponding to the color of the ink used for recording. With this color conversion processing, the CPU 501 generates CMYK data including 4096 values of 12 bits for the data of each color of CMYK. The CPU 501 generates reaction liquid data corresponding to the CMYK data subjected to the color conversion processing. For example, the CPU 501 generates, as reaction liquid data, a tone value of 15% for the tone value of each data.

Next, in step S603, the CPU 501 executes quantization processing on the CMYK data. By this, the CPU 501 generates CMYK data quantized to a binary of 1200 dpi. This quantization processing may be executed based on any of a dither method, an error diffusion method, and the like.

Next, in step S604, the CPU 501 performs index development processing.

Then, in step S605, the CPU 501 performs at least any of mask processing corresponding to multipass recording described later and mask processing of distributing data to a plurality of discharge orifice arrays on the data subjected to the index development processing. By this, the CPU 501 generates record data including 1-bit data for each of the discharge orifice arrays of each recording scan.

According to the record data generated as described above, the recording head 205 discharges ink to record an image on the recording medium P. Note that although the embodiment in which the CPU 501 executes the entire processing of S601 to S605 has been described here, the subject of the processing is not limited to the CPU 501. For example, the PC 516 of the host computer may execute the entire processing of S601 to S605. A form in which the PC 516 executes part of processing.

### Multipass Recording Method

The recording device of the present embodiment records an image by what is called multipass recording in which an image is recorded by a plurality of scans on a predetermined area on the recording medium P using each ink of K, C, M, Y, RCT, WRCT, and W.

Here, multipass layered image recording will be described in which the recording device first records a color ink layer on the recording medium P, records a white ink layer on the color ink layer, and further layers a color ink layer on the white ink layer to record an image.

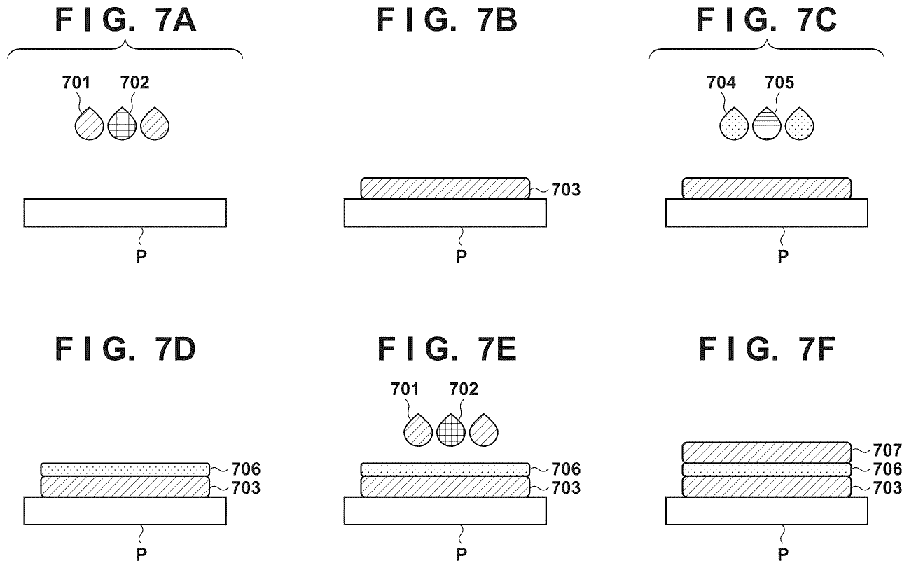

FIGS. 7A to 7F are views describing the recording process in the white layer mode by multipass layered image recording. The recording device of the present embodiment first discharges a color ink 701 and a color RCT ink 702 on the recording medium P (FIG. 7A) to form a color ink layer 703 of a lower layer (FIG. 7B). The recording device discharges a white ink 704 and a WRCT ink 705 on the color ink layer 703 of the lower layer (FIG. 7C) to form a white ink layer 706 (FIG. 7D). The recording device discharges the color ink 701 and the color RCT ink 702 on the white ink layer 706 (FIG. 7E) to form a color ink layer 707 of an upper layer (FIG. 7F). The recording device performs all these processes in the area of the platen 204 of FIG. 2. Thereafter, the recording device forms a layered image by heat in a curing area positioned downstream the platen 204 in the Y direction (conveyance direction).

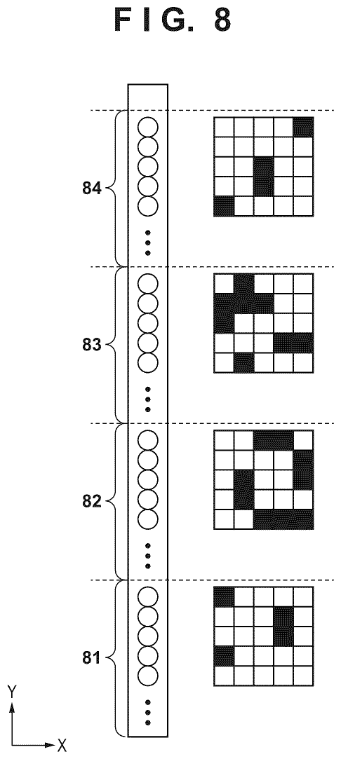

Next, a mask will be described. FIG. 8 is a view for describing a mask pattern. Here, for simplifying the description, each ink of the mask processing of step S605 of FIG. 6 is applied with the same mask pattern illustrated in FIG. 8. Note that description will be made here with an example in which recording scan is performed four times on a unit area to complete recording of an image.

In the mask pattern illustrated in FIG. 8, pixels filled in black indicate pixels (hereinafter, also referred to as a recording permitted area) that permit ink discharge when ink discharge is determined by quantization data. Pixels indicated in white indicate pixels (hereinafter, also referred to as a non-recording permitted area) that do not permit ink discharge even when ink discharge is determined by quantization data.

FIG. 8 illustrates four mask patterns having a size of 5 pixels×5 pixels. By repeatedly applying the four mask patterns in the X direction and the Y direction, the recording device performs distribution processing on all the quantization data corresponding to each unit area. As illustrated in FIG. 8, the number of pixels that permit discharge that exist in each of the four mask patterns is 5 pixels×5 pixels=25 pixels. That is, the recording permissibility is 100% when four pixels that permit discharge the mask pattern of 5 pixels×5 pixels are added.

The recording device performs logical product (AND) processing of a part of the binary data of each ink (size of 5 pixels×5 pixels) and a mask pattern corresponding to each recording scan (each pass). This enables the recording device to generate record data for applying ink in each recording scan.

In the mask pattern corresponding to each recording scan, four recording permitted pixels are arranged in the mask pattern corresponding to the first recording scan (a discharge orifice group 81). Therefore, the recording permissibility of the mask pattern corresponding to the first recording scan is about 16% (=4/25×100). Subsequently, the recording permissibilities of the mask patterns corresponding to the second recording scan (a discharge orifice group 82), the third recording scan (a discharge orifice group 83), and the fourth recording scan (a discharge orifice group 84) are 32%, 36%, and 16%, respectively. Therefore, when this mask pattern is used, the ink is distributed so as to be discharged over the entire discharge orifice array of the recording head. Note that the pattern illustrated in FIG. 8 is a view in which a part of the mask pattern is extracted and illustrated for simplicity, and there is a part slightly different from the recording permissibility.

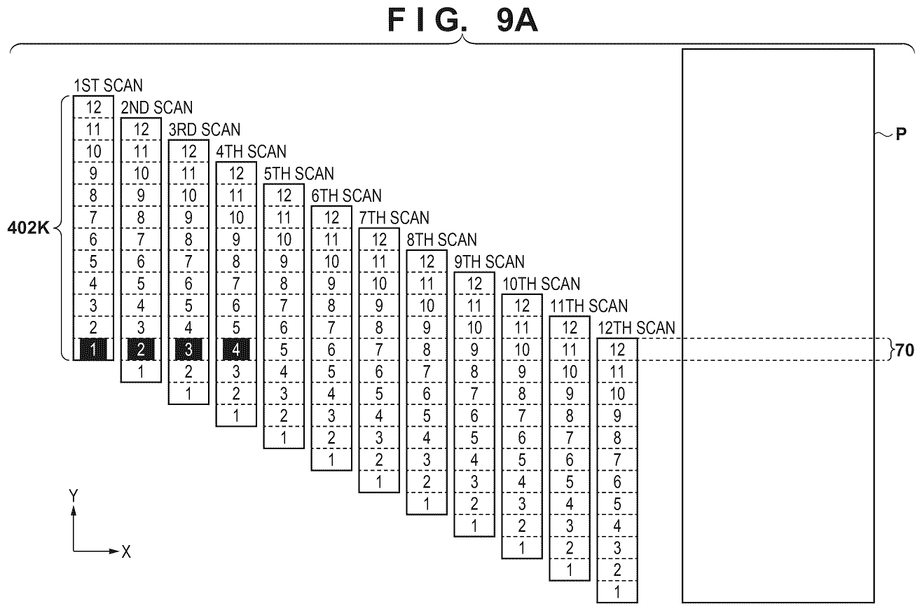

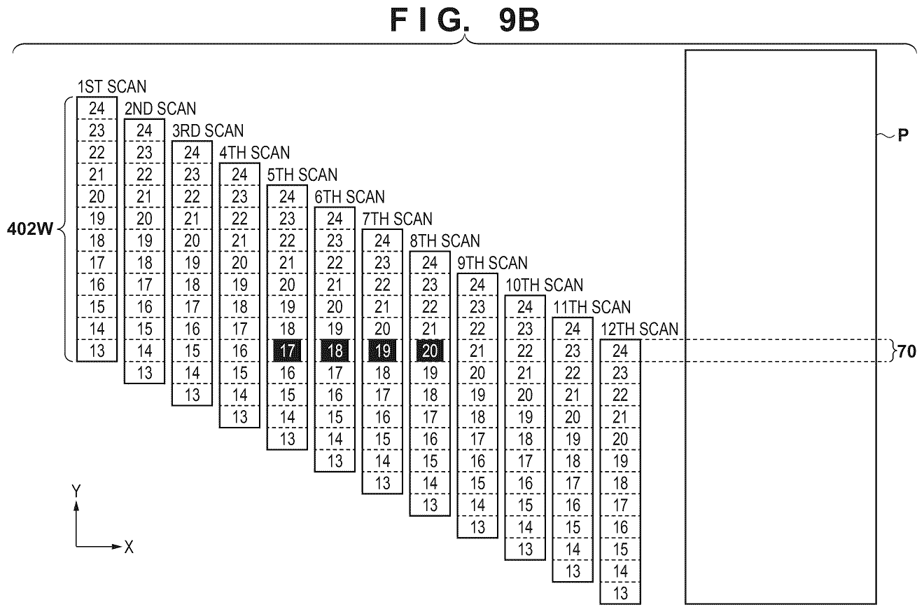

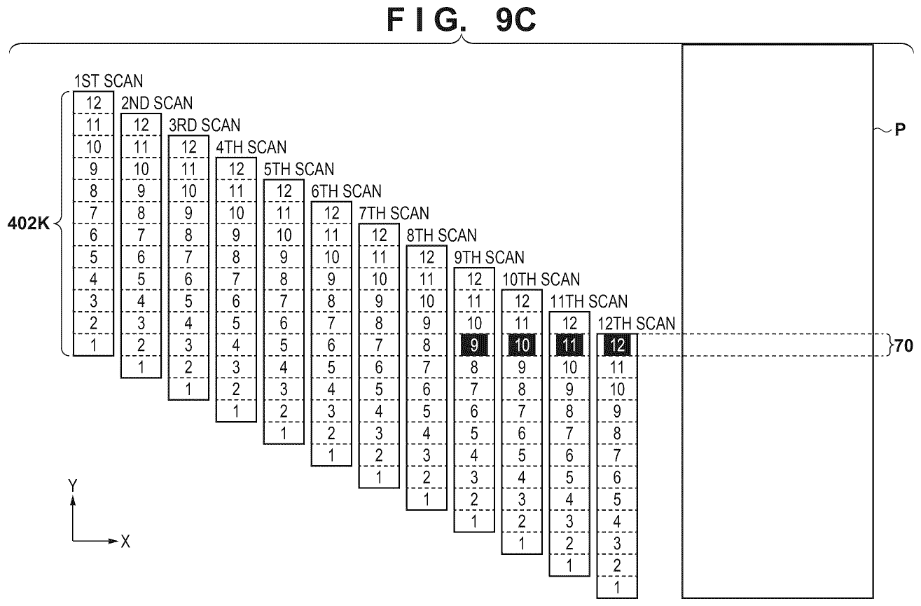

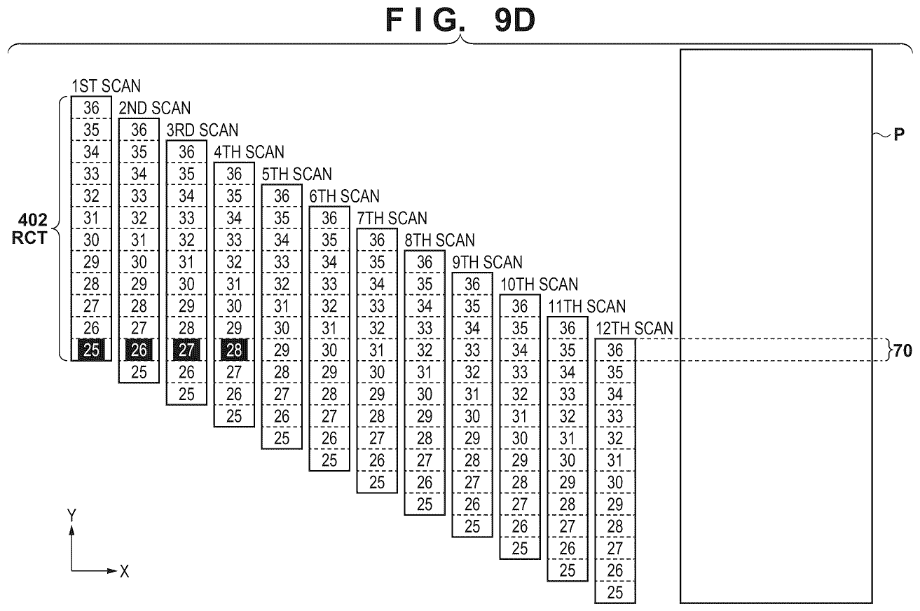

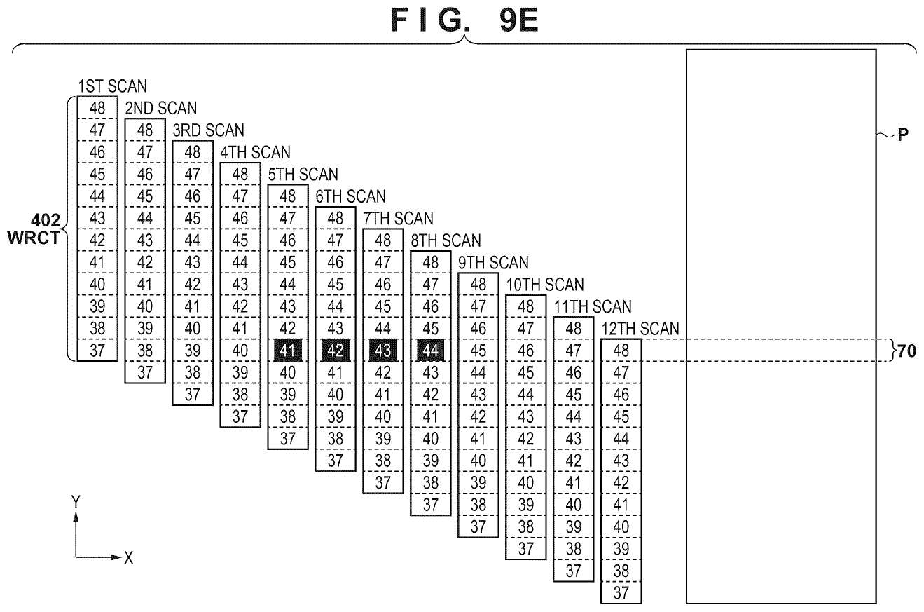

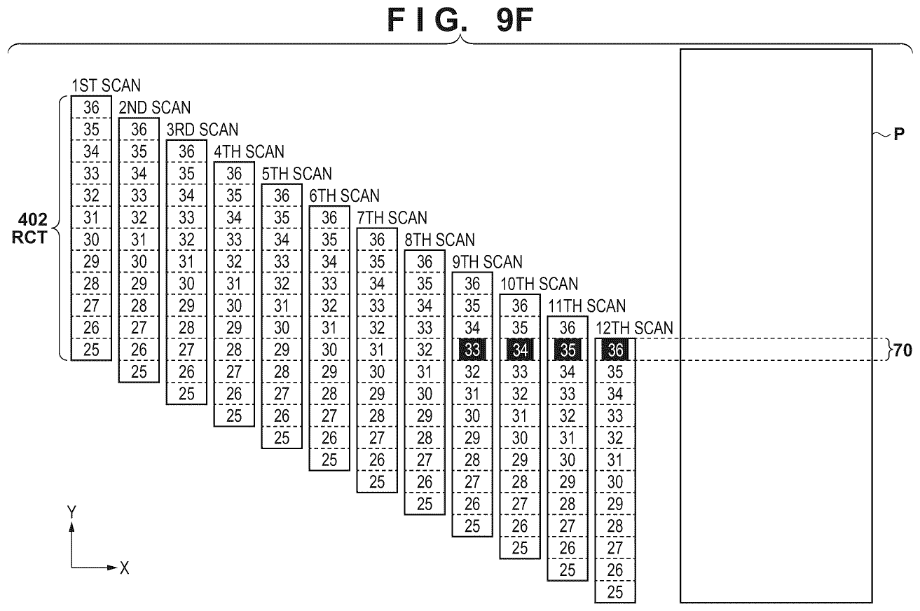

FIG. 9 is a view for describing a multipass layered image recording method in a white layer mode for performing the recording process of FIG. 7. The recording device of the present embodiment performs what is called multipass layered image recording in which a color image (also called a first recorded image) is first recorded on a predetermined area 70 that is a 1/n band on the recording medium P by a plurality (n) of scans by the recording head 205, then a white image (also called a second recorded image) is layered on the color image, and finally a color image (also called a third recorded image) is layered on the white image to record an image.

Here, n=12 is assumed. In this case, the recording device first records the color image in the first four passes, that is, the first to fourth scans to the predetermined area 70 on the recording medium P. Next, the recording device layers a white image on the color image in the middle four passes, that is, the fifth to eighth scans. Next, the recording device layers a color image on the white image in the last four passes, that is, the ninth to twelfth scans to record the image.

FIG. 9A is a view describing recording of the color ink in the first four passes. Recording of the color ink on the recording medium P in the first four passes, that is, the first to fourth scans will be described. Here, recording with the K ink among the color inks will be representatively described. 12 discharge orifice groups 1 to 12 are formed by dividing the discharge orifice array 402K illustrated in FIG. 9A into 12 in the Y direction (conveyance direction). The recording device discharges the K ink from each of the four discharge orifice groups 1 to 4 in each of four scans to the predetermined area 70. On the other hand, the recording device does not discharge the K ink from each of the four discharge orifice groups 5 to 8 of the discharge orifice array 402K in each of the four scans to the predetermined area 70. Note that in reality, the recording device conveys the recording medium P downstream in the Y direction during the scan of the recording head 205, but in FIG. 9, for the sake of simplicity, the recording device moves the recording head 205 upstream in the Y direction during the scan.

First, in the first scan, the recording device scans the recording head 205 in a state where the predetermined area 70 on the recording medium P and the discharge orifice group 1 of the discharge orifice array 402K oppose each other. In this scan, the recording device discharges the K ink from the discharge orifice group 1 to the predetermined area 70 according to the record data corresponding to the K ink corresponding to the first scan. After the first scan ends, the recording device conveys the recording medium P in the Y direction by a distance corresponding to one discharge orifice group. Thereafter, the recording device performs the second scan, and discharges the K ink from the discharge orifice group 2 to the predetermined area 70. Subsequently, the recording device alternately performs conveyance of the recording medium P and discharge of the K ink from the recording head 205 to discharge the ink from the discharge orifice group 3 and the discharge orifice group 4 in the third and fourth scans to the predetermined area 70. In this manner, the recording device completes multipass recording of the K ink on the lower layer to the predetermined area 70.

FIG. 9B is a view describing recording of the white ink in the middle four passes. Next, recording of the white ink on the recording medium P in the middle four passes, that is, the fifth to eighth scans will be described. 12 discharge orifice groups 13 to 24 illustrated in FIG. 9B are formed by dividing the discharge orifice array 402W into 12 in the Y direction (conveyance direction). The recording device discharges the white ink from each of the four discharge orifice groups 17 to 20 in each of four scans to the predetermined area 70. On the other hand, the recording device does not discharge the white ink to the predetermined area 70 in each of eight scans from each of the four discharge orifice groups 13 to 16 and the four discharge orifice groups 21 to 24 of the discharge orifice array 402W. First, in the fifth scan, the recording device scans the recording head 205 in a state where the predetermined area 70 on the recording medium P and the discharge orifice group 17 of the discharge orifice array 402W oppose each other. The recording device discharges the white ink from the discharge orifice group 17 to the predetermined area 70 according to the record data of the white ink corresponding to the fifth scan. After the fifth scan ends, the recording device conveys the recording medium P in the Y direction by the distance corresponding to one discharge orifice group. Thereafter, the recording device performs the sixth scan, and discharges the white ink from the discharge orifice group 18 to the predetermined area 70. Subsequently, the recording device alternately performs conveyance of the recording medium P and discharge of the white ink from the recording head 205, and executes discharge of the white ink from the discharge orifice groups 19 and 20 to the predetermined area 70 in the seventh and eighth scans. In this manner, the recording device layers the white ink on the K ink layer previously recorded on the predetermined area 70. By this, the recording device completes multipass recording of the white ink to the predetermined area 70.

FIG. 9C is a view describing recording of the color ink in the last four passes. Next, recording of the color ink in the last four passes, that is, the ninth to twelfth scans will be described. Here, the K ink among the color inks will be representatively described. The 12 discharge orifice groups 1 to 12 illustrated in FIG. 9C are formed by dividing the discharge orifice array 402K into 12 in the Y direction (conveyance direction). The recording device discharges the K ink from each of the four discharge orifice groups 9 to 12 in each of four scans to the predetermined area 70.

First, in the ninth scan, the recording device scans the recording head 205 in a state where the predetermined area 70 on the recording medium P and the discharge orifice group 9 of the discharge orifice array 402K oppose each other, and discharges the K ink from the discharge orifice group 9 to the predetermined area 70 according to the record data of the K ink corresponding to the ninth scan. After this ninth scan ends, the recording device conveys the recording medium P in the Y direction by the distance corresponding to one discharge orifice group. Thereafter, the recording device performs the tenth scan, and discharges the K ink from the discharge orifice group 10 to the predetermined area 70. Subsequently, the recording device alternately performs conveyance of the recording medium P and discharge from the recording head 205 to discharge the K ink from the discharge orifice groups 9 to 12 in the ninth to twelfth scans to the predetermined area 70. In this manner, the recording device layers the K ink layer on the white ink layer of the predetermined area 70. By this, the recording device completes multipass recording of the K ink on the upper layer to the predetermined area 70.

The recording device layers the C, M, and Y inks similarly to the case of the K ink illustrated in FIGS. 9A and 9C. In this manner, the recording device completes multipass recording of the C, M, and Y inks to the predetermined area 70.

As for the color RCT and the WRCT, as illustrated in FIGS. 9D to 9F, the recording device first records the color RCT in the first four passes, that is, the first to fourth scans. The recording device layers the WRCT on the layer of the color RCT in the middle four passes, that is, the fifth to eighth scans. The recording device layers the color RCT on the WRCT layer in the last four passes, that is, the ninth to twelfth scans. Hereinafter, the layer of the RCT will be described in detail.

FIG. 9D is a view describing recording of the color RCT in the first four passes. 12 discharge orifice groups 25 to 36 illustrated in FIG. 9D are formed by dividing the discharge orifice array 402RCT into 12 in the Y direction (conveyance direction). In the first four passes, that is, in each of the first to fourth scans, the recording device discharges the color RCT from each of the four discharge orifice groups 25 to 28 to the predetermined area 70 to record the color RCT. On the other hand, the recording device does not discharge the color RCT from each of the four discharge orifice groups 29 to 32 in each of the four scans to the predetermined area 70.

First, in the first scan, the recording device scans the recording head 205 in a state where the predetermined area 70 on the recording medium P and the discharge orifice group 25 of the discharge orifice array 402RCT oppose each other, and discharges the color RCT from the discharge orifice group 25 to the predetermined area 70 according to the record data of the color RCT corresponding to the first scan. After this first scan ends, the recording device conveys the recording medium P by the distance corresponding to one discharge orifice group in the Y direction. Thereafter, the recording device performs the second scan, and discharges the color RCT from the discharge orifice group 26 to the predetermined area 70. Subsequently, the recording device alternately performs conveyance of the recording medium P and discharge of the color RCT from the recording head 205, and discharges the color RCT from the discharge orifice group 27 and the discharge orifice group 28 to the predetermined area 70 in the third and fourth scans. By this, the recording device completes multipass recording of the color RCT to the lower layer of the predetermined area 70.

FIG. 9E is a view illustrating recording of the WRCT in the middle four passes. 12 discharge orifice groups 37 to 48 illustrated in FIG. 9E are formed by dividing the discharge orifice array 402WRCT into 12 in the Y direction (conveyance direction). In order to record the WRCT in the middle four passes, that is, the fifth to eighth scans, the recording device discharges the WRCT from each of the four discharge orifice groups 41 to 44 in each of the four scans to the predetermined area 70. On the other hand, the recording device does not discharge the WRCT from each of the four discharge orifice groups 37 to 40 and the four discharge orifice groups 45 to 48 in each of the eight scans to the predetermined area 70. First, in the fifth scan, the recording device scans the recording head 205 in a state where the predetermined area 70 on the recording medium P and the discharge orifice group 41 of the discharge orifice array 402WRCT oppose each other, and discharges the WRCT from the discharge orifice group 41 to the predetermined area 70 according to the record data of the WRCT corresponding to the fifth scan. After the fifth scan ends, the recording device conveys the recording medium P in the Y direction by the distance corresponding to one discharge orifice group. Thereafter, the recording device performs the sixth scan, and discharges the WRCT from the discharge orifice group 42 to the predetermined area 70. Subsequently, the recording device alternately performs conveyance of the recording medium P and discharge of the WRCT from the recording head 205 to discharge the WRCT from the discharge orifice group 43 and the discharge orifice group 44 in the seventh and eighth scans to the predetermined area 70. By this, the recording device completes multipass recording of the WRCT to the predetermined area 70.

FIG. 9F is a view describing recording of the color RCT in the last four passes. The 12 discharge orifice groups 25 to 36 illustrated in FIG. 9F are formed by dividing the discharge orifice array 402RCT into 12 in the Y direction (conveyance direction). In order to record the color RCT in the last four passes, that is, the ninth to twelfth scans, the recording device discharges the color RCT from each of the four discharge orifice groups 33 to 36 in each of the four scans to the predetermined area 70.

First, in the ninth scan, the recording device scans the recording head 205 in a state where the predetermined area 70 on the recording medium P and the discharge orifice group 33 of the discharge orifice array 402RCT oppose each other, and discharges the color RCT from the discharge orifice group 33 to the predetermined area 70 according to the record data of the color RCT corresponding to the ninth scan. After the ninth scan ends, the recording device conveys the recording medium P in the Y direction by the distance corresponding to one discharge orifice group. Thereafter, the recording device performs the tenth scan, and discharges the color RCT from the discharge orifice group 34 to the predetermined area 70. Subsequently, the recording device alternately performs conveyance of the recording medium P and discharge from the recording head 205 to discharge the color RCT from the discharge orifice group 33 to the discharge orifice group 36 in the ninth to twelfth scans to the predetermined area 70. By this, the recording device completes multipass recording of the color RCT to the upper layer of the predetermined area 70.

Note that although a case of scanning 12 times the recording head 205 on the predetermined area 70 to record an image has been described here, the number of scans is not limited to this. The image may be recorded with more than 12 scans. In this case, the width in the Y direction of the predetermined area is narrower than that of the above-described predetermined area 70. The image may be recorded with less than 12 scans. In this case, the width in the Y direction of the predetermined area is wider than that of the above-described predetermined area 70. Although an example of recording a color image in the first four passes, a white image in the middle four passes, and a color image in the last four passes among the 12 scans is presented here, the number of passes for recording an image is not limited to this. The number of passes of the white image and the number of passes of the color image may be different from those in the above example.

Although a case of recording an image by recording a color image first on a predetermined area of the recording medium P, layering a white image on the color image, and further layering a color image on the white image has been described, but the number of layers is not limited to this. For example, the number of layers may be two or five (a color image, a white image, a black image, a white image, and a color image).

### Characteristic Configuration

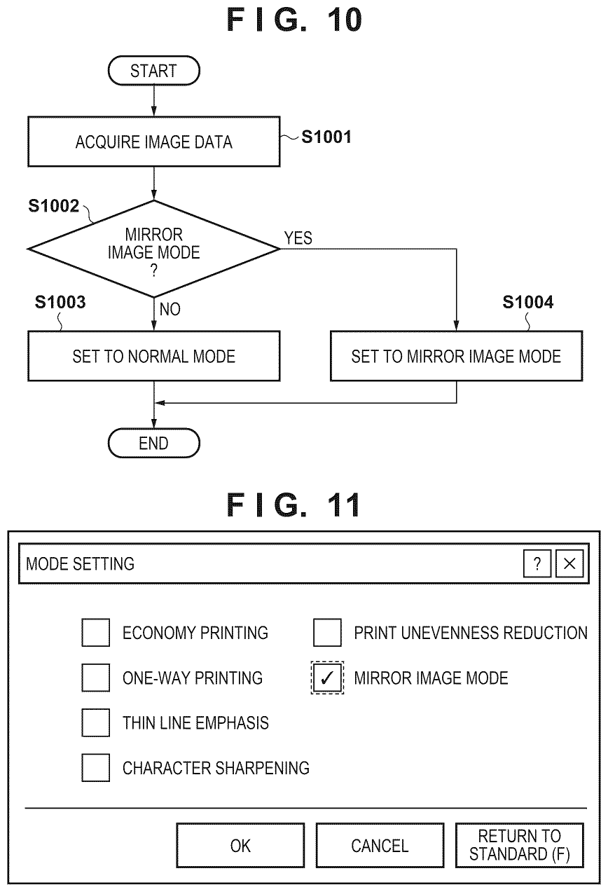

FIG. 10 is a view showing a flowchart of recording mode setting processing according to the embodiment. The recording mode setting processing will be described with reference to FIG. 10. The recording mode setting processing is processing of setting a drying condition for drying ink, which is a feature of the embodiment. The recording mode setting processing is executed by the CPU 501 reading a computer program for the recording mode setting processing stored in the storage 505.

In S1001, the CPU 501 acquires image data input from the user.

Next, in S1002, the CPU 501 determines whether the recording mode selected by the user is a mirror image mode or a normal mode. The mirror image is defined as the first recorded image and the third recorded image being the same images and being plane-symmetric about the second recorded image. For example, if the first recorded image (an image of a color ink layer of a lower layer) and the third recorded image (an image of a color ink layer of an upper layer) are the same images and at the same positions about the second recorded image (an image of a white ink layer that is a middle shielding layer), the images of the both color ink layers are mirror images. The mirror image mode is a recording mode for a case where the first recorded image and the third recorded image are mirror images. The normal mode is a recording mode for a case where the first recorded image and the third recorded image are not mirror images (i.e., in a case of a non-mirror image). The CPU 501 varies a condition of drying for controlling drying of the ink of each layer between the mirror image mode and the normal mode.

FIG. 11 is a view illustrating an example of a mode setting screen (user interface (UI)) on which the user selects a recording mode. The mode setting screen is displayed on a display of the PC 516 of the host computer, for example. The user checks a check box of the “mirror image mode” of FIG. 11 on the mode setting screen, thereby setting the recording mode to the mirror image mode. In this case, the CPU 501 may determine that the user has set the recording mode to the mirror image mode. On the other hand, when the user has not checked the “mirror image mode”, the CPU 501 may determine that the user has not set the recording mode to the mirror image mode.

When determining that the recording mode set by the user is not the mirror image mode in S1002, the CPU 501 proceeds to S1003.

In S1003, the CPU 501 sets the normal mode as the recording mode. The CPU 501 sets the drying condition for drying the ink stronger in the normal mode than that in the mirror image mode. That is, the normal mode is a recording mode in which the ink of the upper layer is discharged after the ink of the lower layer is sufficiently dried, and is a recording mode in which the ink of the upper layer is sufficiently suppressed from being immersed in the ink of the lower layer.

When determining that the recording mode set by the user is the mirror image mode in S1002, the CPU 501 proceeds to S1004.

In S1004, the CPU 501 sets the mirror image mode as the recording mode. The CPU 501 sets the drying condition for drying the ink weaker in the mirror image mode than in the normal mode. For example, the mirror image mode is a recording mode in which the drying time is shortened and the drying strength is lowered as compared with the normal mode.

Here, the acquisition step of the mirror image mode in S1002 uses the UI screen displayed on a monitor of the PC 516 of the host computer, but display of the UI screen is not limited to this. For example, the acquisition step of the mirror image mode may use an operation unit prepared in the recording device.

As described above, when recording an image, the CPU 501 sets the drying condition according to the above-described recording mode, and dries the ink of each layer. That is, the CPU 501 varies the drying condition between when the recording mode is the mirror image mode for the case where the first recorded image and the third recorded image are mirror images and when the recording mode is the normal mode for the case where the first recorded image and the third recorded image are not mirror images. Specifically, when the normal mode is set as the recording mode, the CPU 501 increases the drying strength as compared with the case of the mirror image mode, and sufficiently dries the color ink of at least the lower layer. When the mirror image mode is set as the recording mode, the CPU 501 dries the color ink of at least the lower layer by reducing the drying strength as compared with the case of the normal mode. Note that the CPU 501 may dry the ink of each layer based on the above-described drying condition set according to the recording mode.

### Mechanism Characteristic in Present Embodiment

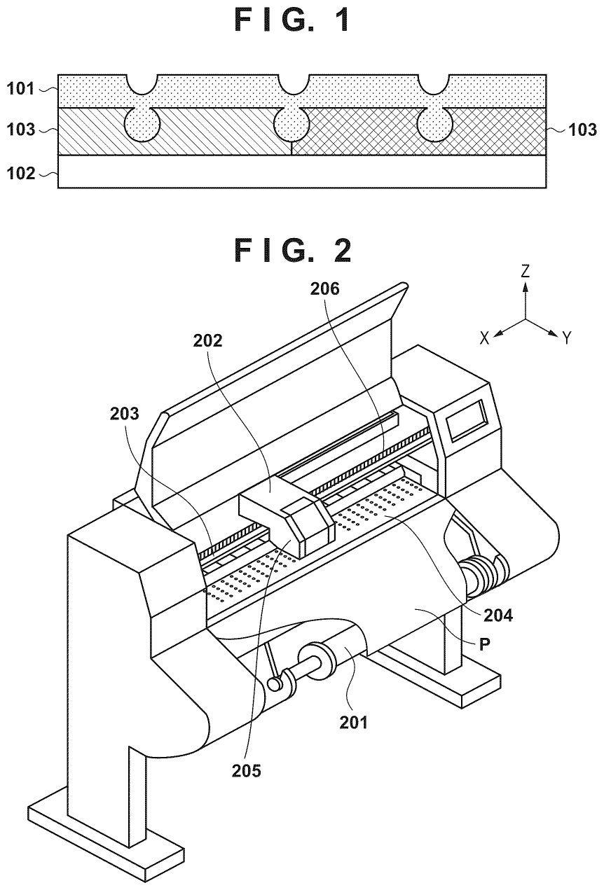

FIG. 1 is a view describing immersion of ink in a layered image. As illustrated in FIG. 1, in a case of a layered image, when a white ink layer 101 of an upper layer is layered in a state where a color ink layer 103 of a lower layer is not dried, what is called immersion in which the white ink layer 101 of the upper layer sinks into the color ink layer 103 of the lower layer recorded on a transparent recording medium 102 occurs. For example, when the drying of the color ink layer 103 of the lower layer corresponding to the first recorded image recorded with the color ink discharged from the first discharge orifice group is insufficient, a part of the white ink layer 101 of the upper layer corresponding to the second recorded image discharged from the second discharge orifice group is immersed in the color ink layer 103 of the lower layer. By this, shielding by the white ink layer 101 becomes insufficient, and when the observer observes from the side of the white ink layer 101, show-through of the color ink layer 103 occurs. Therefore, in order to suppress show-through, it is necessary to sufficiently dry the color ink layer 103 of the lower layer, and it is necessary to sufficiently provide the drying time of the color ink layer 103 of the lower layer or sufficiently provide the drying strength of the color ink layer 103 of the lower layer. As a result, there arises a problem of productivity decrease due to ensuring of sufficient drying time, or power consumption increases due to ensuring of sufficient drying strength.

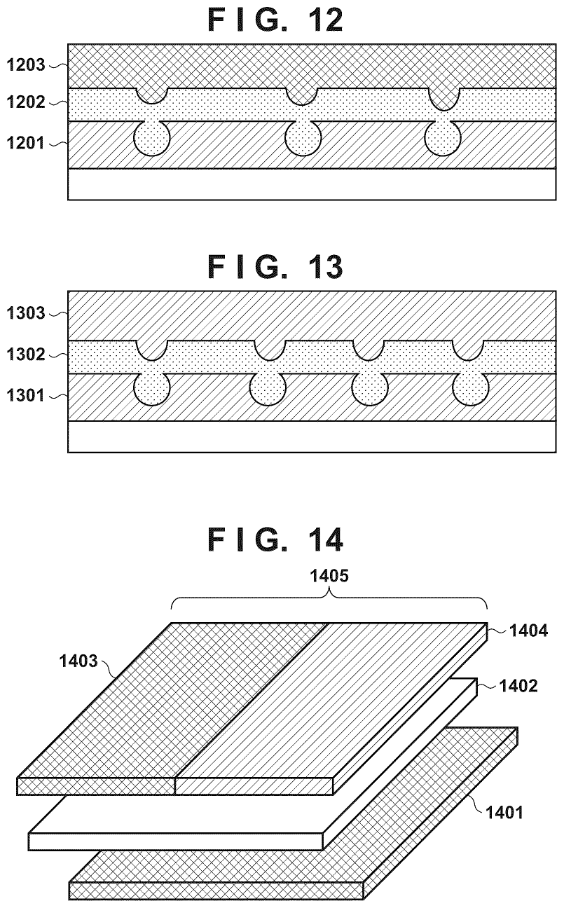

FIG. 12 is a view describing an influence of immersion when the first recorded image and the third recorded image are non-mirror images. In the case of a layered image having a three-layer structure, as illustrated in FIG. 12, when the white ink is landed from above in a state where drying of a first recorded image 1201 is insufficient, the white ink highly tends to be immersed in the first recorded image 1201, and unevenness is generated in a white ink layer 1202. As a result, the first recorded image 1201 is not sufficiently shielded by the white ink layer 1202, and when a third recorded image 1203 is recorded, show-through by the first recorded image 1201 occurs.

FIG. 13 is a view describing an influence of immersion when the first recorded image and the third recorded image are mirror images. Here, an influence of show-through due to unevenness of a white ink layer 1302, which is the second recorded image, in a case where a first recorded image 1301 and a third recorded image 1303 are in a mirror image relationship as illustrated in FIG. 13 will be considered. In the case of the mirror image, a difference of chroma of colors between the first recorded image 1301 and the third recorded image 1303 is smaller than that in a case of a non-mirror image. As illustrated in FIG. 13, in the case where the first recorded image 1301 and the third recorded image 1303 are in the mirror image relationship, the white ink layer 1302 is not sufficiently shielded, and even if show-through occurs, the difference of chroma between the first recorded image 1301 and the third recorded image 1303 is small, and therefore it can be considered that the influence on the legibility becomes small. Note that the difference of chroma may be referred to as a chroma change, a color difference, or the like.

### Evaluation Method in Embodiment

An evaluation method of the embodiment will be described. FIG. 14 is a view illustrating an example of an evaluation image for evaluation. The evaluation image for evaluating the embodiment is an image in which a uniform green area, as a first recorded image 1401, a shielding layer using white ink, as a second recorded image 1402, and a layer including a green area 1403 and a purple area 1404, as a third recorded image 1405, are layered as illustrated in FIG. 14. The green area is printed with 50% Y ink and 50% C ink at 45 ng/600 dpi. The shielding layer is printed with white ink at 18 ng/600 dpi. The purple area 1404 is printed with 49% M ink, 39% LM ink, and 12% LC ink at 45 ng/600 dpi. The green area 1403 of the third recorded image 1405 uses the same image as the first recorded image 1401. Therefore, the green area 1403 of the third recorded image 1405 is in a mirror image relationship with the first recorded image 1401. Here, dpi is a relative resolution indicating the number of dots per inch. ng is an abbreviation for nanogram, and is the mass of one drop of ink.

The reaction liquid (color RCT) for the color ink is applied 15% in terms of the number of dots with respect to the color ink. The reaction liquid (WRCT) for the white ink is applied 15% in terms of the number of dots with respect to the white ink.

A recording medium used was GIY-0305, which is a window decorative light transmissive super PET base material film (strong adhesion type) manufactured by Lintec Corporation.

Colorimetry was performed using a fluorescence spectrodensitometer (FD-7: manufactured by Konica Minolta, Inc).

As a specific evaluation method, the evaluation image illustrated in FIG. 14 was recorded under different drying conditions (hereinafter, also called drying conditions), and the chromas of the green area 1403 and the purple area 1404 of the third recorded image 1405 and the chroma of the first recorded image 1401 were measured. Furthermore, a difference of chroma ΔC*, which is a difference between the chromas of the green area 1403 and the purple area 1404 of the third recorded image 1405 and the chroma of the first recorded image 1401, was calculated and acquired. The drying strength will be described in detail in each embodiment.

In the evaluation this time, from the viewpoint of whether or not a color change of the third recorded image 1405 due to unevenness of the white ink layer that is the second recorded image 1402 can be visually observed, it is determined as OK when the difference of chroma ΔC* is less than 2.0, and it is determined as NG when the difference of chroma ΔC* is 2.0 or more.

### First Embodiment

A feature of the present embodiment is to control a scanning time per reciprocation as drying strength. In the present embodiment, the scanning time per reciprocation of the recording head is set to 5.23 s as the first recording condition, and the scanning time per reciprocation of the recording head is set to 3.23 s as the second recording condition. Here, the first recording condition indicates a condition including the drying condition of the normal mode in FIG. 10. The second recording condition indicates a condition including the drying condition of the mirror image mode in FIG. 10. The number of passes and the air blowing strength (temperature_airflow speed) of the platen air blow unit 302, which are other conditions, were the same. The recording conditions in the present embodiment are shown in Table 1 below.

TABLE 1

| | FIRST | SECOND |
|---|---|---|
| | RECORDING | RECORDING |
| | CONDITION | CONDITION |
| NUMBER OF PASSES (FIRST | 16/16/16 | 16/16/16 |
| RECORDED IMAGE/SECOND | | |
| RECORDED IMAGE/ | | |
| THIRD RECORDED IMAGE) | | |
| SCANNING TIME PER | 5.23 s | 3.23 s |
| RECIPROCATION | | |
| AIR BLOWING STRENGTH | 32° C._{—} | 32° C._{—} |
| (TEMPERATURE_AIRFLOW | 2.5 m/s | 2.5 m/s |
| SPEED) | | |

Note that the number of passes may be referred to as the number of times of scanning. The CPU 501 may control the scanning time by either the scanning speed or the standby time between scans. The scanning time is related to the drying time and the drying strength. Specifically, the longer the scanning time is, the longer the drying time is, and the stronger the drying strength is. On the other hand, the shorter the scanning time is, the shorter the drying time is, and the weaker the drying strength is. The CPU 501 may control the heater 306 to adjust the temperature of the air blowing strength of the platen. The CPU 501 may control the fan 307 to adjust the airflow speed of the air blowing strength of the platen.

Table 2 below shows the result (difference of chroma ΔC*) evaluated under the recording conditions described above. * is a chroma C*.

TABLE 2

| | MIRROR IMAGE | NON-MIRROR IMAGE |
|---|---|---|
| FIRST RECORDING | ∘(REFERENCE) | ∘(REFERENCE) |
| CONDITIO | *38.7 | *41.6 |
| SECOND RECORDING | ∘(ΔC*0.9) | ∘(ΔC*2.0) |
| CONDITION | *37.8 | *39.6 |

In the green area 1403, the difference of chroma ΔC* between the case of being immersed and the case of not being immersed is 0.9. This can be considered that since the first recorded image 1401 and the third recorded image 1405 have the same color, the difference of chroma ΔC* is small even if there is show-through. On the other hand, in the purple area 1404, the difference of chroma ΔC* between the case of being immersed and the case of not being immersed is 2.0. This can be considered to be because when the ink of the second recorded image 1402 is immersed, shielding by the second recorded image 1402 is insufficient, and thus the color of the green area that is the first recorded image 1401 affects the color of the purple area 1404 of the third recorded image 1405.

Thus, when the first recorded image 1401 and the third recorded image 1405 are in a mirror image relationship, the influence of show-through due to immersion on the image is small. That is, in the case of the mirror image, the influence on the image is small even if the time between scans of the recording head 205, which is the time for drying the ink, is shortened, the drying time is reduced, and the drying strength is weakened.

Based on this result, in the recording device of the first embodiment, recording conditions that also serve as drying conditions are set as in Table 3 below.

TABLE 3

| | MIRROR IMAGE | NON-MIRROR IMAGE |
|---|---|---|
| FIRST | SECOND RECORDING | FIRST RECORDING |
| EMBODIMENT | CONDITION | CONDITION |
| | (SCANNING TIME | (SCANNING TIME |
| | 3.23 s) | 5.23 s) |
| COMPARATIVE | FIRST RECORDING | FIRST RECORDING |
| EXAMPLE | CONDITION | CONDITION |
| | (SCANNING TIME | (SCANNING TIME |
| | 5.23 s) | 5.23 s) |

The recording device of the first embodiment is applied with the second recording condition having low drying strength as the drying condition of the mirror image mode. By this, in the first embodiment, it is possible to appropriately dry an image, particularly the first recorded image, which is the image of the lower layer, with an appropriate drying time and drying strength according to whether the recording mode is the mirror image mode for mirror image or the normal mode. As a result, in the first embodiment, it is possible to improve the productivity by shortening of the drying time and reduce the power consumption necessary for drying, while the first recorded image and the third recorded image are appropriately shielded by the second recorded image of the white ink according to the image to suppress the influence on the image quality due to show-through.

In the present embodiment, the drying time that is a recording condition may be adjusted by adjustment of the number of passes of the second recorded image 1402 to an extent that immersion does not affect the third recorded image 1405, and sandwiching a blank (scan not for recording) between the second recorded image 1402 and the third recorded image 1405.

### Second Embodiment

Next, a second embodiment will be described. In the second embodiment, description of similar content to that of the first embodiment in the device configuration of the recording device, the ink configuration, the recording medium, and the like will be simplified.

In the first embodiment, an effect of productivity improvement by shortening the scanning time per reciprocation to shorten the drying time has been described. A feature of the second embodiment is to control the number of scans for forming an image, particularly the first recorded image, to control the drying strength.

In the present embodiment, the first recorded image is recorded in 26 passes as the first recording condition, and the first recorded image is set to 16 passes as the second recording condition. Other conditions such as the scanning time per reciprocation and the air blowing strength were the same. The recording conditions in the present embodiment are shown below.

TABLE 4

| | FIRST | SECOND |
|---|---|---|
| | RECORDING | RECORDING |
| | CONDITION | CONDITION |
| NUMBER OF PASSES (FIRST | 26/16/16 | 16/16/16 |
| RECORDED IMAGE/SECOND | | |
| RECORDED IMAGE/THIRD | | |
| RECORDED IMAGE) | | |
| SCANNING TIME PER | 3.33 s | 3.33 s |
| RECIPROCATION | | |
| AIR BLOWING STRENGTH | 32° C._{—} | 32° C._{—} |
| (TEMPERATURE_AIRFLOW | 2.5 m/s | 2.5 m/s |
| SPEED) | | |

Table 5 below shows the result (difference of chroma ΔC*) evaluated under the recording conditions described above. * is the chroma C*.

TABLE 5

| | MIRROR IMAGE | NON-MIRROR IMAGE |
|---|---|---|
| FIRST RECORDING | ◯(REFERENCE) | ◯(REFERENCE) |
| CONDITION | *39.1 | *43.1 |
| SECOND RECORDING | ◯(ΔC*0.8) | ◯(ΔC*2.3) |
| CONDITION | *39.9 | *40.8 |

In the green area 1403, the difference of chroma ΔC* between the case of being immersed and the case of not being immersed is 0.8. This can be considered that since the first recorded image 1401 and the green area 1403 of the third recorded image have the same color, the difference of chroma ΔC* is small even if there is show-through. On the other hand, in the purple area 1404, the difference of chroma ΔC* between the case of being immersed and the case of not being immersed is 2.3. This can be considered to be because in the case of being immersed, shielding by the second recorded image 1402 is insufficient, and thus the color of the green area of the first recorded image 1401 affects the color of the purple area 1404 of the third recorded image 1405.

Thus, when the first recorded image 1401 and the third recorded image 1405 are in a mirror image relationship, the influence of show-through due to immersion on the image is small. Therefore, in the case of the mirror image, the influence on the image is small even if the number of passes for recording the first recorded image 1401 is reduced to reduce the drying time.

Based on this result, in the present embodiment, recording conditions that also serve as drying conditions are set as in Table 6 below.

TABLE 6

| | MIRROR IMAGE | NON-MIRROR IMAGE |
|---|---|---|
| SECOND | SECOND RECORDING | FIRST RECORDING |
| EMBODIMENT | CONDITION | CONDITION |
| | (16 PASSES) | (26 PASSES) |
| COMPARATIVE | FIRST RECORDING | FIRST RECORDING |
| EXAMPLE | CONDITION | CONDITION |
| | (26 PASSES) | (26 PASSES) |

The recording device of the second embodiment can appropriately set the drying strength according to the image by applying the second recording condition as the drying condition of the mirror image mode. By this, in the second embodiment, it is possible to improve the productivity and reduce the power consumption necessary for drying, while suppressing the influence of show-through on the image quality.

### Third Embodiment

Next, a third embodiment will be described. In the third embodiment, description of similar content to that of the first embodiment in the device configuration of the recording device, the ink configuration, the recording medium, and the like will be simplified. In the description of the third embodiment, differences from the above-described embodiments will be mainly described.

In the above-described embodiments, the effect of productivity improvement by shortening the scanning time has been described.

A feature of the present embodiment is to control the air blowing strength from the platen air blow unit 302. In the present embodiment, the air blowing strength (temperature_airflow speed) of the platen is set to 40° C._3.5 m/s as the first recording condition, and the air blowing strength of the platen is set to 32° C._2.5 m/s as the second recording condition. The number of passes and the scanning time, which are other conditions, were the same. The recording conditions in the present embodiment are shown below. The CPU 501 may control the heater 306 to adjust the temperature of the air blowing strength of the platen. The CPU 501 may control the fan 307 to adjust the airflow speed of the air blowing strength of the platen.

TABLE 7

| | FIRST | SECOND |
|---|---|---|
| | RECORDING | RECORDING |
| | CONDITION | CONDITION |
| NUMBER OF PASSES (FIRST | 16/16/16 | 16/16/16 |
| RECORDED IMAGE/SECOND | | |
| RECORDED IMAGE/THIRD | | |
| RECORDED IMAGE) | | |
| SCANNING TIME PER | 3.33 s | 3.33 s |
| RECIPROCATION | | |
| AIR BLOWING STRENGTH | 40° C._{—} | 32° C._{—} |
| (TEMPERATURE_AIRFLOW | 3.5 m/s | 2.5 m/s |
| SPEED) | | |

Table 8 below shows the result (difference of chroma ΔC*) evaluated under the recording conditions described above. * is the chroma C*.

TABLE 8

| | MIRROR IMAGE | NON-MIRROR IMAGE |
|---|---|---|
| FIRST RECORDING | ◯(REFERENCE) | ◯(REFERENCE) |
| CONDITION | *40.4 | *44.5 |
| SECOND RECORDING | ◯(ΔC*0.5) | ◯(ΔC*3.7) |
| CONDITION | *39.9 | *40.8 |

In the green area 1403, the difference of chroma ΔC* between the case of being immersed and the case of not being immersed is 0.5. This can be considered that since the first recorded image 1401 and the third recorded image 1405 have the same color, the difference of chroma ΔC* is small even if there is show-through. In the purple area 1404, the difference of chroma ΔC* between the case of being immersed and the case of not being immersed is 3.7. This can be considered to be because when the ink of the second recorded image 1402 is immersed, shielding by the second recorded image 1402 is insufficient, and thus the color of the green area that is the first recorded image 1401 affects the color of the purple area 1404 of the third recorded image 1405.

Thus, when the first recorded image 1401 and the third recorded image 1405 are mirror images, the influence of show-through due to immersion on the image is small. That is, in the case of the mirror image, the influence on the image is small even if the air blowing strength is weakened.

Based on this result, in the present embodiment, recording conditions that also serve as drying conditions are set as in Table 9 below.

TABLE 9

| | MIRROR IMAGE | NON-MIRROR IMAGE |
|---|---|---|
| THIRD | SECOND RECORDING | FIRST RECORDING |
| EMBODIMENT | CONDITION | CONDITION |
| | (32° C., 2.5 m/s) | (40° C., 3.5 m/s) |
| SECOND | FIRST RECORDING | FIRST RECORDING |
| RECORDING | CONDITION | CONDITION |
| CONDITION | (40° C., 3.5 m/s) | (40° C., 3.5 m/s) |

The recording device of the third embodiment can appropriately set the drying strength according to the image by applying the second recording condition as the drying condition of the mirror image mode. By this, in the third embodiment, it is possible to reduce the power consumption necessary for drying, while suppressing the influence of show-through on the image quality.

### OTHER EMBODIMENTS

In the present embodiment, under the conditions of the recording mode at the time of the mirror image described above, a single condition among the scanning time per reciprocation of the recording head, the number of passes, and the air blowing strength may be changed, or a plurality of conditions may be changed. In each recording mode, any one of the temperature and the airflow speed of air blowing may be changed as the air blowing strength.

In the above-described embodiments, an example in which the user selects the mirror image mode or the normal mode as the recording mode has been described, but the setting of the recording mode is not limited to this. For example, the CPU 501 may determine whether or not the first recorded image and the third recorded image are mirror images based on image data, and when determining that they are mirror images, set the mirror image mode.

The above-described embodiments may be combined. The drying conditions may be appropriately combined by the user or the CPU 501.

According to the present disclosure, when images are layered and recorded, the images can be appropriately dried.

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-156832, filed Sep. 10, 2024, which is hereby incorporated by reference herein in its entirety.

What is claimed is:

1. A control device that controls an inkjet recording device including a recording head that discharges ink onto a recording medium that is light transmissive to layer and record an image, the control device comprising:
a generation unit that generates record data for recording an image in which at least a first recorded image, a second recorded image, and a third recorded image are layered in this order on one surface of the recording medium; and
a drying control unit that controls drying of ink of each layer depending on a recording mode, which is a mode for recording an image, wherein
the drying control unit varies a condition of drying between when the recording mode is a mirror image mode for a case where the first recorded image and the third recorded image are mirror images and when the recording mode is a normal mode for a case where the first recorded image and the third recorded image are not mirror images.

2. The control device according to claim 1, wherein
the drying control unit shortens a drying time for drying the first recorded image in a case of the mirror image mode as compared with a case of the normal mode.

3. The control device according to claim 2, wherein
the recording head records an image by scanning in a scanning direction that is a direction intersecting a conveyance direction of the recording medium, and
the drying control unit shortens the drying time by shortening scanning time of the recording head in the case of the mirror image mode as compared with the case of the normal mode.

4. The control device according to claim 2, wherein
the recording head records an image by scanning in a scanning direction that is a direction intersecting a conveyance direction of the recording medium, and
the drying control unit shortens the drying time by increasing a scanning speed of the recording head in the case of the mirror image mode as compared with the case of the normal mode.

5. The control device according to claim 2, wherein
the drying control unit shortens the drying time by decreasing a number of times of scanning of the recording head for recording the first recorded image in the case of the mirror image mode as compared with the case of the normal mode.

6. The control device according to claim 1, wherein
the drying control unit decreases drying strength for drying the first recorded image in the case of the mirror image mode as compared with the case of the normal mode.

7. The control device according to claim 6, wherein
the drying control unit decreases the drying strength by lowering temperature of air to be sent for drying in the case of the mirror image mode as compared with the case of the normal mode.

8. The control device according to claim 6, wherein
the drying control unit decreases the drying strength by decreasing an airflow speed of air to be sent for drying in the case of the mirror image mode as compared with the case of the normal mode.

9. The control device according to claim 1, wherein
the generation unit generates record data so as to record the second recorded image with white ink.

10. The control device according to claim 1, wherein
the drying control unit receives selection of the mirror image mode from a user.

11. An inkjet recording device comprising:
the control device according to claim 1;
a recording head that includes a discharge orifice group including a first discharge orifice group, a second discharge orifice group, and a third discharge orifice group divided along a conveyance direction of a recording medium, and discharges ink onto a recording medium that is light transmissive to record an image; and
a drying unit that dries the discharged ink.

12. A control method that controls an inkjet recording device including a recording head that discharges ink onto a recording medium that is light transmissive to layer and record an image, the method comprising:
generating record data for recording an image in which at least a first recorded image, a second recorded image, and a third recorded image are layered in this order on one surface of the recording medium; and
controlling drying of ink of each layer depending on a recording mode, which is a mode for recording an image, wherein
in the controlling of drying, a condition of drying is varied between when the recording mode is a mirror image mode for a case where the first recorded image and the third recorded image are mirror images and when the recording mode is a normal mode for a case where the first recorded image and the third recorded image are not mirror images.

13. A non-transitory computer-readable storage medium storing a computer program for causing, when loaded and executed by a computer that controls an inkjet recording device t including a recording head that discharges ink onto a recording medium that is light transmissive to layer and record an image, the computer to:
generate record data for recording an image in which at least a first recorded image, a second recorded image, and a third recorded image are layered in this order on one surface of the recording medium; and
control drying of ink of each layer depending on a recording mode, which is a mode for recording an image, wherein
in the controlling of drying, a condition of drying is varied between when the recording mode is a mirror image mode for a case where the first recorded image and the third recorded image are mirror images and when the recording mode is a normal mode for a case where the first recorded image and the third recorded image are not mirror images.
